(19) United States
(12) Patent Application Publication
(10) Pub. No.: US 2026/0022002 A1
(43) Pub. Date: Jan. 22, 2026

(54) BEVERAGE CAN OPENING AND SEALING TOOL

(71) Applicant: JLS PUBLISHING LLC, Charlotte, NC (US)

(72) Inventor: Brett Jordan Van Leeuwen, Bellingham, WA (US)

(21) Appl. No.: 18/774,525

(22) Filed: Jul. 16, 2024

(51) Int. Cl. B67B 7/40

(52) U.S. Cl. CPC B67B 7/403

(57) ABSTRACT

The present disclosure relates to a can opening and sealing tool with a body portion comprising a lower section and an upper section designed to engage securely with a can's pull-tab. The upper section includes a bar with an indented central portion that provides haptic feedback to confirm successful tab engagement and prevent accidental disengagement. An arm portion extends radially from a connecting portion and is configured to assist a user in pivoting the tool around the can's rivet when the tool is fully engaged with the can. The arm portion's edge interacts with the can’s top annular edge to maintain a flush seal.

### TECHNICAL FIELD

The present disclosure relates generally to devices used for opening and sealing containers. More specifically, the disclosure in one example pertains to a tool designed for engaging with and operating the tabs of cans, such as those commonly found on beverage and food cans, facilitating both the opening and resealing of the can.

### BRIEF SUMMARY

Existing can covers and opening mechanisms in the beverage industry face significant limitations, particularly in usability and effectiveness. Firstly, many existing products struggle with installation across varying thicknesses of aluminum can tabs, making them less user-friendly and accessible. The typical designs do not account for the small variations in can manufacturing, which can affect the ease of attachment and the overall user experience.

Secondly, current solutions often fail to provide a secure seal over the can's rim. While some competitors' products may rotate around the can's opening, they frequently do not engage securely with the rim, leading to an imperfect seal. This inadequacy allows for the ingress of dirt, insects, and other contaminants, compromising the beverage's cleanliness and the consumer's enjoyment. Such products merely rest on top without a latching mechanism, which can easily be dislodged, failing to offer a reliable barrier against external elements.

Accordingly, there is a noticeable absence of designs that latch onto the can's rim to ensure a tight seal. This gap highlights the need for a more robust solution that not only simplifies the opening process but also enhances the sealing function to maintain the beverage's integrity throughout consumption.

This disclosure presents a can opening and sealing tool configured to interact efficiently with various types of beverage cans. The tool features a body portion with a lower and upper section that engages with a can's pull-tab mechanism.

The upper section of the body portion includes an integrated bar with an indented central portion that provides haptic feedback during operation, helping to confirm successful engagement with the tab. This feature ensures the tool provides slight resistance during attachment and helps prevent accidental disengagement from the tab. The tool’s configuration incorporates a connecting portion that forms a contoured fit around the can’s top annular edge, leading to an arm portion extending radially for effective leverage. This arm facilitates a smooth rotational action, allowing the user to seal and unseal the can with minimal effort.

The arm portion’s edge in one example interacts directly with the can’s top annular edge to fully engage the tool with the can, ensuring the tool's lower section aligns flush with the can's top wall for a secure seal. This alignment and the mechanical advantages in one example include effective edge connection and disconnection, which are enhanced by the positioning of the arm portion below a defined plane, which also positions the arm portion conveniently away from a user’s face during beverage consumption.

Additional examples include variations in the positioning of the arm relative to the upper section, the use of phosphorescent materials for visibility, and the application of a sealant material on the lower section's bottom surface to improve sealing efficacy. The disclosure also includes examples where the bar’s intended central portion’s geometry facilitates easier attachment than detachment. This tool's construction and design ensures minimal wear and tear even with repeated use, making it a robust solution for beverage can opening and sealing needs that overcomes the aforementioned issues.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top plan view of a can opening and sealing tool in accordance with an embodiment of the present invention;

FIG. 2 is a perspective view of the can opening and sealing tool of FIG. 1;

FIG. 3 is a left-side elevation view of the can opening and sealing tool of FIG. 1, the opposing side view being a mirror image thereof;

FIG. 4 is a partial cross-sectional left-side elevation view taken along line A-A’ in FIG. 1, showing the can opening and sealing tool engaged with a can; and,

FIG. 5 is a perspective view of the can opening and sealing tool of FIG. 1, also engaged with a can.

The drawings described herein are for illustration purposes and are not intended to limit the scope of the disclosure.

### DETAILED DESCRIPTION

In the following description, to better understand the aforementioned purposes, features, and advantages of the disclosure, numerous specific details are set forth in order to provide a thorough understanding. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed herein.

The specification may refer to "an", "one" or "some" embodiment(s) in several locations. This does not necessarily imply that each such reference is to the same embodiment(s), or that the feature only applies to a single embodiment except as recited in the claims. A single feature of different embodiments may also be combined to provide other embodiments.

Throughout this disclosure, the term "can" refers to a standard beverage can or equivalent container made of aluminum, steel, or similar materials. Although the can opening and sealing tool described herein is depicted with a standard modern aluminum can typically holding about 12 ounces (355 ml) of fluid, the design of the tool can be readily adjusted to accommodate various can types. These include slim cans, which are elongated and sleek, usually holding about 12 ounces but with a slimmer profile; mini cans, which are smaller and hold approximately 7.5 to 8 ounces; and tall cans, which are larger, ranging from 16 to 24 ounces, often used for specialty drinks or beer.

Although the tool is described herein as being designed to open and seal cans with a pull-tab opening mechanism, it can be readily adapted to effectively open cans with other types of opening mechanisms.

Throughout the disclosure, the terms "proximal" and "distal" are used. The term "distal" refers to the portion of the tool or an element of the tool that is closer to the can's radial center when the tool is engaged with the can. The term "proximal" refers to the portion of the tool or an element of the tool that is further away from the can's radial center when the tool is engaged with the can. In some examples, the radial center is at or near the central rivet.

Throughout the disclosure, the terms ‘seal’ and 'sealing' are used. However, it is important to clarify that ‘seal’ or 'sealing' should not be interpreted as necessarily providing an airtight, watertight, or permanent seal unless such functionality is explicitly described. Instead, ‘seal’ or 'sealing' should be understood in the context of this invention as facilitating the containment of liquids within a can, including but not limited to, preventing splashing or substantial leakage when the can is subject to movement or jostling. Similarly, the terms 'seal' and 'sealing' should also be understood to encompass preventing contaminants such as dirt, insects, and the like from entering the can when the tool is engaged with the can.

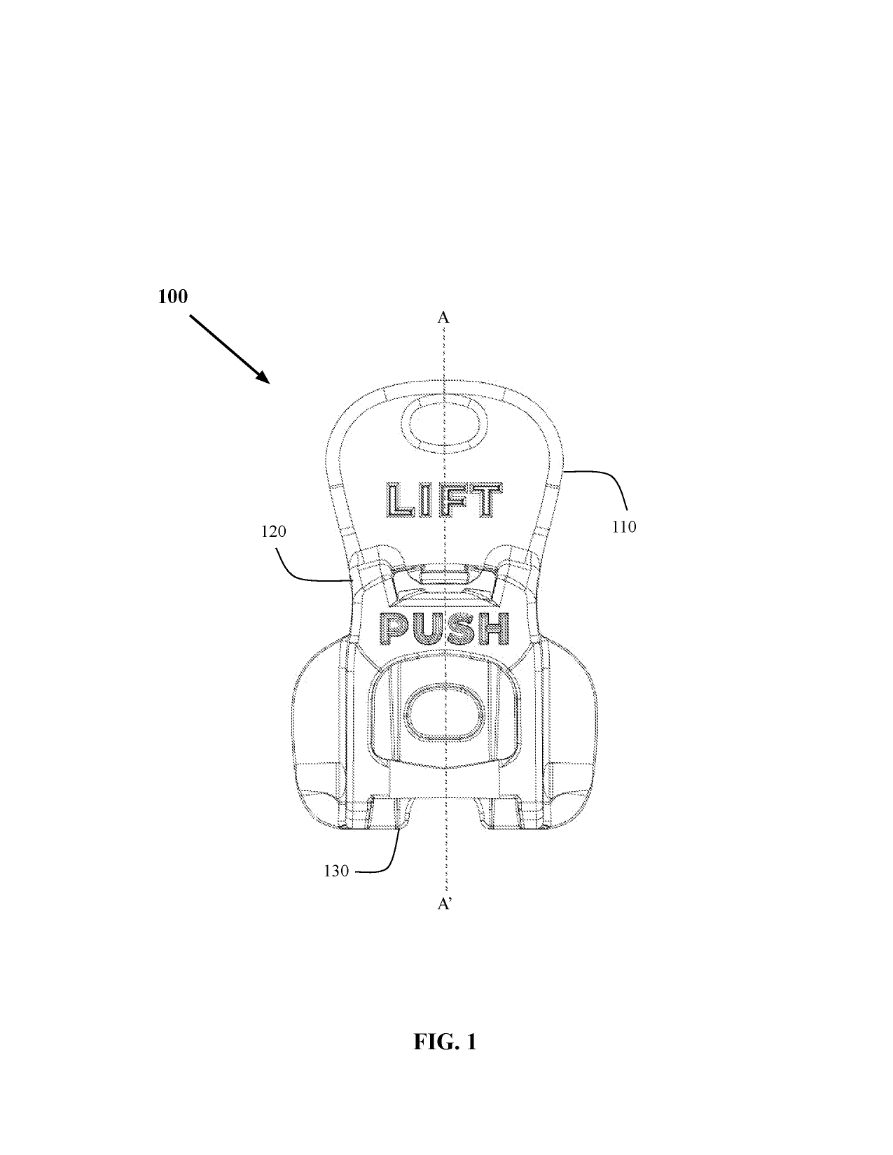

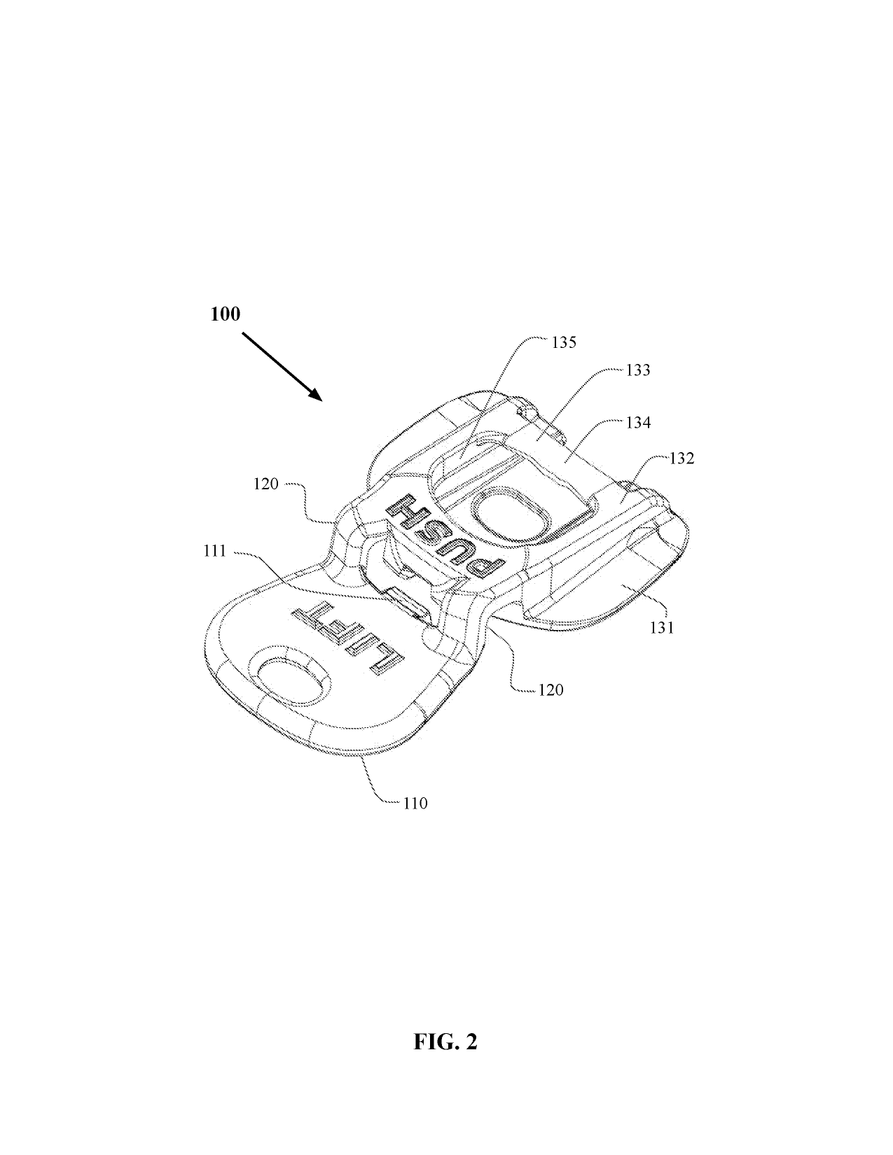

Referring to the example of FIGS. 1, 2, and 3, the can opening and sealing tool 100 comprises a body portion 130, designed to detachably engage with the tab of a can. The body portion 130 includes a lower section 131 and an upper section 132. The upper surface of the lower section is configured to engage the underside of the tab, facilitating a secure connection when the tool 100 is in use.

The upper section 132 extends upwards from the lower section 132 and the upper section’s internal coupling surface 135 is contoured to fit securely around the tab of the can. A bar 133 is integrated across the upper section. This bar 133 provides structural stability and additional leverage against the tab when operating the tool 100.

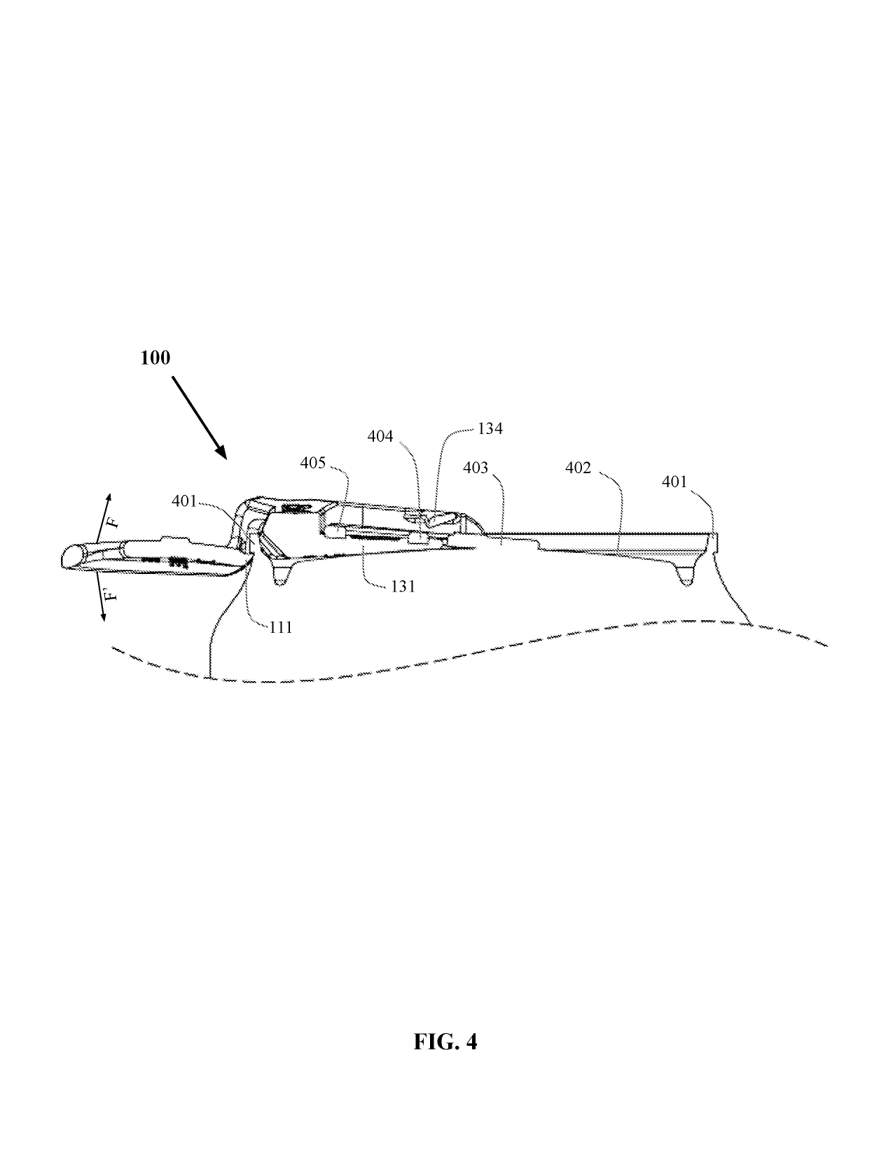

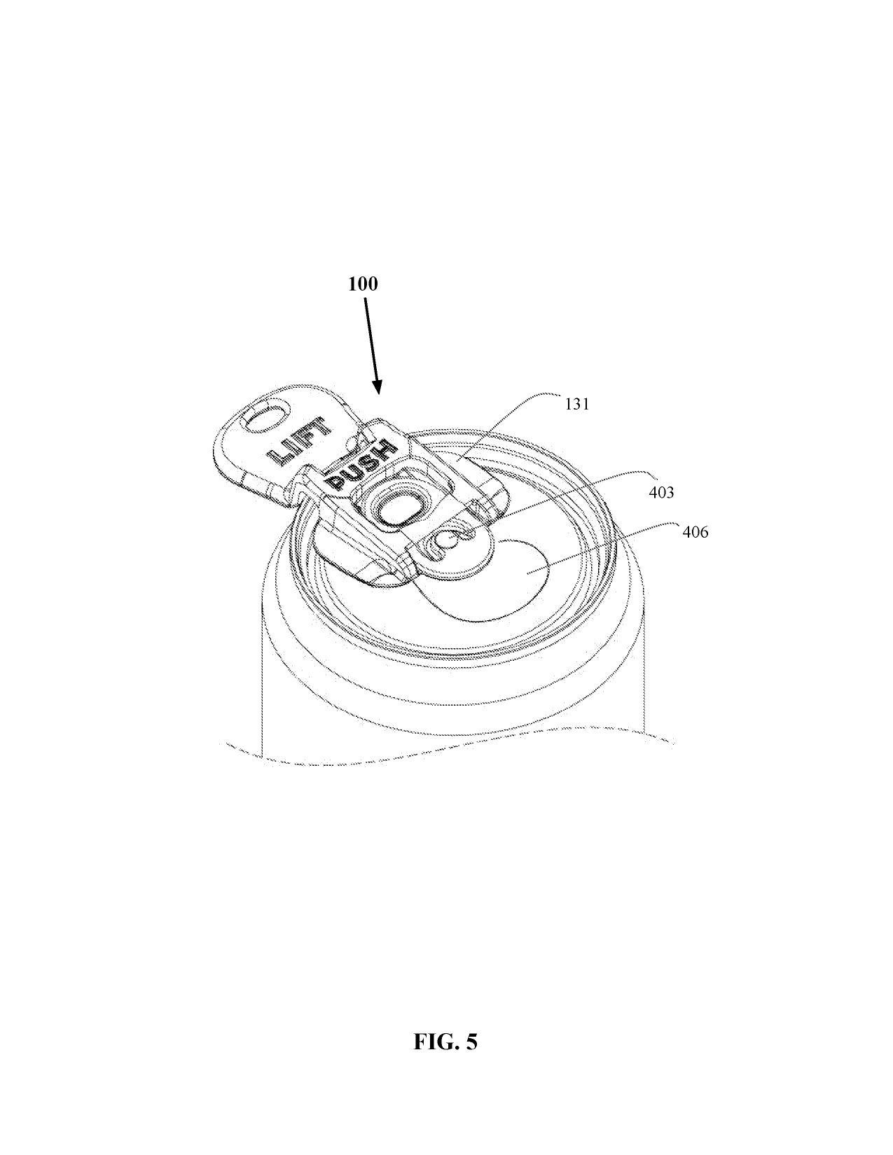

In the one example, the bar 133 includes an indented central portion 134 designed to provide tactile feedback to the user as they operate the tool 100. When the can opening and sealing tool 100 is engaged with the tab of a can, this indented central portion 134 interacts with specific features of the tab, such as the tab's outer edge 405 or the tab bridge 404 (see FIGS. 4 and 5). The indentation 134 is placed and shaped to ensure that as the indentation 134 encounters the edge or bridge of the tab, the indentation 134 provides a slight resistance followed by a release, signaling to the user through haptic feedback that the tool 100 has successfully gripped a given portion the tab for effective engagement and disengagement. Furthermore, when the tool 100 is fully engaged with the tab—for example, when the indentation 134 is positioned between the can’s rivet 403 and the tab’s bridge—the indentation provides slight lateral resistance that prevents the tool 100 from accidentally disengaging from the tab.

The connecting portion 120 of the can opening and sealing tool 100 serves as the transitional element between the main body portion 130 and the arm portion 110. The connecting portion is angled to provide a contoured fit around the can’s top annular edge 402.

The arm portion 110 extends radially from the distal end of the connecting portion 120, providing the leverage needed for the operation of the tool 100. The arm portion 110 of the tool has enough surface area to provide a user with an area to grip when engaging and disengaging the can’s tab. The arm portion’s radial extension past the can’s top annular edge 402 also facilitates a smooth, rotational pivoting action around the can’s rivet 403, allowing the user to seal and unseal the can with minor effort when the tool 100 is fully engaged with the can.

The arm portion’s edge 111 is designed to engage directly with the can’s top annular edge 401. In one example, when the arm portion’s edge 111 is engaged with the can’s top annular edge, the lower section 131 of the body portion 130 is substantially flush with the can's top wall 401. The specific configuration of the arm portion’s edge facilitates the correct positioning of the tool, preventing slippage, and providing a consistent sealing action/seal. When the body portion is engaged with the tab and the arm portion's edge is engaged with the can's top annular edge, this state is referred to as being fully engaged or achieving full engagement.

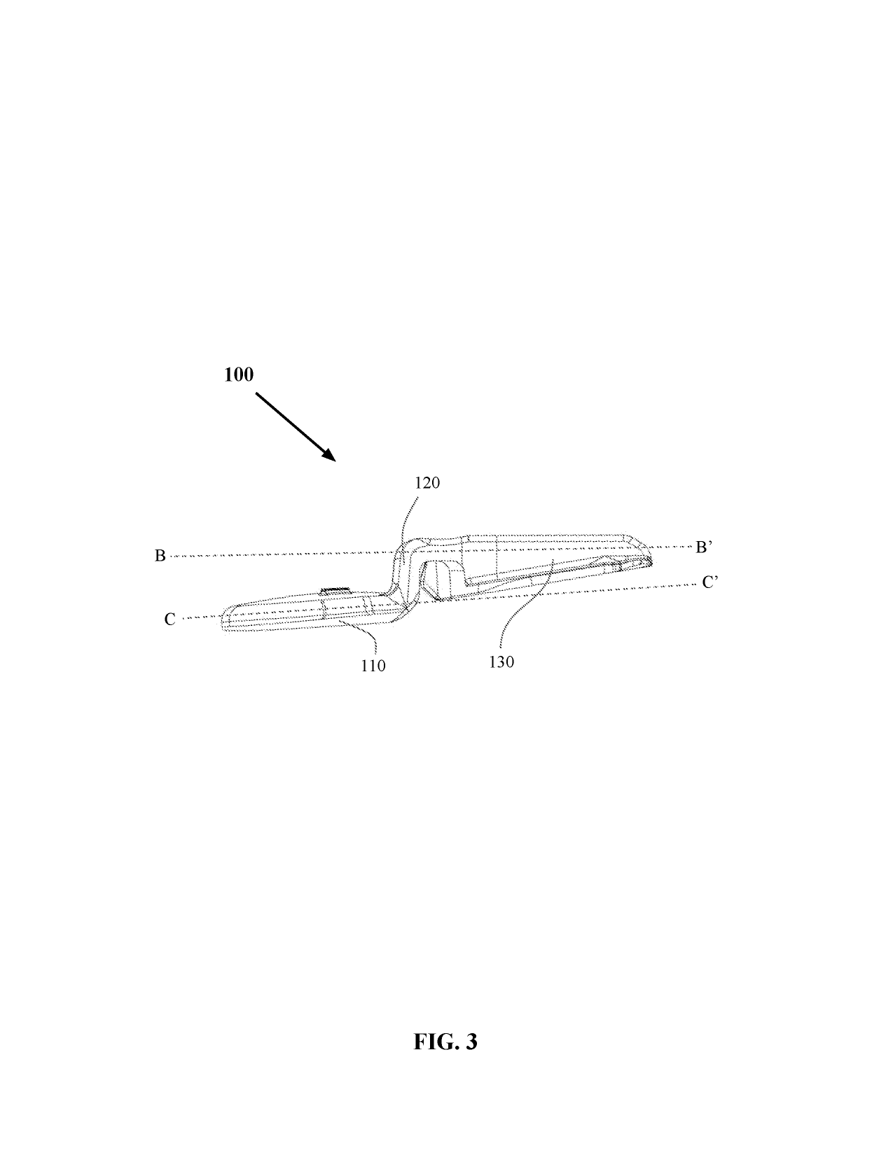

Referring now to FIGS. 3, 4, and 5, in the one example, the arm portion 110 lies entirely below the plane B-B' defined by the upper section. This positioning is due to the elevation drop between the body portion 130 and the arm portion 110, which results from the shape of the connecting portion 120. Having the arm portion lie below this plane offers several advantages. These advantages include, but are not limited to, positioning the arm portion further from a user’s face while consuming the beverage inside the can when the tool 100 is fully engaged, and providing a mechanically advantageous edge connection and disconnection when a force F or F', respectively, is applied by a user onto the distal end of the arm portion 110. The selectively flexible material construction of one example of the connecting portion 130 and the arm portion 110 enable a snap attachment of the tool 100 to the can, that causes minimal, if any, damage or distortion of the tool 100 with repeated use.

Referring to FIG. 4, the tool 100, as it would be positioned when fully engaged with the can, is shown via a partial cross-sectional left-side elevation view taken along line A-A’ from FIG. 1. In the one example, the tab’s outer edge 405 and bridge 404 are frictionally engaged by the upper surface of the lower section 131 of the tool 100.

In the one example, the area of the lower section 131 is sufficiently large to completely cover and seal the can opening 406 when the tool 100 is fully engaged with the can (e.g., the fully engaged tool can be selectively rotated around the rivet 403 until the can opening 406 is completely covered by the lower section).

In some embodiments, a plane C-C' defined by the arm and a plane B-B' defined by the top surface of the upper section are substantially parallel.

In some embodiments, a plane C-C' defined by the arm and a plane B-B' defined by the top surface of the upper section converge at an angle between 1 and 30 degrees.

In some embodiments, the body portion 130 is located entirely within the can’s top annular edge when the tool is fully engaged with the can. In some embodiments, when the tool is maximally engaged with the tab, the center of the bar is positioned within 7 millimeters of the center of the can’s rivet.

In some embodiments, the tool comprises a phosphorescent (phosphor) material.

In some embodiments, the bottom surface of the lower section 131 comprises a sealant material such as silicone, plastic, or equivalents. In such embodiments, when the lower section 131 covers an open section of the can’s top wall 402, the lower section 131 provides a substantially airtight and/or watertight seal, although it may not be strictly airtight or watertight.

In some embodiments, the indentation 134 is shaped such that attaching the tool 100 to the tab requires less force than removing the tool 100 from the tab. Some embodiments achieve this force differential by having the radial portion of the indentation have a steeper angle in relation to the plane defined by the top surface of the upper section than that of the distal portion.

Even though particular combinations of features are recited in the claims and/or disclosed in the specification, these combinations are not intended to limit the disclosure. Many of these features disclosed herein may be combined in ways not specifically recited in the claims and/or disclosed in the specification nor shown in the drawings.

I claim:

1. A can opening and sealing tool comprising:
a body portion configured to detachably engage a tab of a can, the body portion comprising:
a lower section having an upper surface, a portion of the upper surface configured to engage the underside of the tab;
an upper section extending upwards from the lower section, configured to provide a contoured fit around the tab, the upper section having a bar extending across the upper section;
a connecting portion attached to the distal end of the body portion, the connecting portion configured to provide a contoured fit around a top annular edge of the can; and,
an arm portion attached to the distal end of the connecting portion, the arm portion extending radially past the top annular edge.

2. The can opening and sealing tool of claim 1, wherein the bar extends across a proximal end of the upper section, such that when the tool is maximally engaged with the tab, the center of the bar is positioned within 7 millimeters of the center of the can’s rivet.

3. The can opening and sealing tool of claim 1, wherein a center of the bar is indented towards the lower section, such that when the tool is engaged with the tab, haptic feedback is provided as the indented section engages and overcomes an outer edge or a bridge of the tab.

4. The can opening and sealing tool of claim 1, wherein the arm portion comprises an edge configured to engage the can’s top annular edge, such that when the top annular edge of the can is engaged by the arm portion’s edge, the lower section is substantially flush with the planar surface of the can’s top wall.

5. The can opening and sealing tool of claim 4, wherein, once the tool is engaged with the tab and the arm’s edge is engaged with the can’s top annular edge, the tool can be radially rotated around the can’s rivet to selectively seal and unseal the can.

6. The can opening and sealing tool of claim 5, wherein once the tool is engaged with the tab and the edge is engaged with the top annular edge, the arm portion lies below a plane defined by the top surface of the upper section.

7. The can opening and sealing tool of claim 6, wherein a plane defined by the arm and the plane defined by the top surface of the upper section are substantially parallel.

8. The can opening and sealing tool of claim 6, wherein a plane defined by the arm and the plane defined by the top surface of the upper section converge at an angle between 1-30 degrees.

9. The can opening and sealing tool of claim 1, wherein the body portion is located within the top annular edge of the can when the can is sealed with the tool.

10. The can opening and sealing tool of claim 1, wherein the tool comprises a phosphorescent material.

11. The can opening and sealing tool of claim 1, wherein the bottom surface of the lower section comprises a sealant material.

12. A can opening and sealing tool comprising:
a body portion configured to detachably engage a tab of a can, the body portion comprising:
a lower section having an upper surface;
a portion of the upper surface configured to engage an underside of the tab;
an upper section extending upwards from the lower section, the upper section configured to provide a contoured fit around the tab;
a connecting portion attached to a distal end of the body portion, the connecting portion configured to provide a contoured fit around the can’s top annular edge; and,
an arm portion attached to a distal end of the connecting portion, the arm portion extending radially past a top annular edge of the can.

13. The can opening and sealing tool of claim 12, wherein the arm portion includes an edge configured to engage the can’s top annular edge, such that when the can’s top annular edge is engaged by the arm portion’s edge, the lower section is substantially flush with the planar surface of the can’s top wall.

14. The can opening and sealing tool of claim 13, wherein once the tool is engaged with the tab and the edge is engaged with the top annular edge, the arm portion lies below a plane defined by the top surface of the upper section.

15. The can opening and sealing tool of claim 14, wherein a plane defined by the arm and the plane defined by the top surface of the upper section are substantially parallel.

16. The can opening and sealing tool of claim 14, wherein a plane defined by the arm and the plane defined by the top surface of the upper section converge at an angle between 1-30 degrees.

17. A can opening and sealing tool comprising:
a body portion configured to detachably engage a tab of a can, the body portion comprising:
a lower section having an upper surface, a portion of the upper surface configured to engage the underside of the tab;
an upper section extending upwards from the lower section, the upper section configured to provide a contoured fit around the tab;
a connecting portion attached to the distal end of the body portion; and,
an arm portion attached to the distal end of the connecting portion.

18. The can opening and sealing tool of claim 17, wherein the arm portion includes an edge configured to engage the underside of a top annular edge of the can.

19. The can opening and sealing tool of claim 18, wherein a bar extends across the upper section and the center of the bar is indented towards the lower section.

20. The can opening and sealing tool of claim 19, wherein a radial portion of the indentation of the bar has a steeper angle in relation to a place defined by the top surface of the upper section than that of the distal portion of the indentation of the bar.
